(19) United States
(12) Patent Application Publication
(10) Pub. No.: US 2026/0336132 A1
(43) Pub. Date: Oct. 29, 2026

(54) CONTROL SYSTEM

(71) Applicant: TOYOTA JIDOSHA KABUSHIKI KAISHA, Toyota-shi (JP)

(72) Inventors: Susumu Oikawa, Yokohama-shi (JP); Akihito Goto, Nagoya-shi (JP); Takemitsu Mori, Nisshin-shi (JP); Yasuhiro Ebihara, Okazaki-shi (JP)

(73) Assignee: TOYOTA JIDOSHA KABUSHIKI KAISHA, Toyota-shi (JP)

(21) Appl. No.: 19/446,055

(22) Filed: Jan. 12, 2026

(30) Foreign Application Priority Data
Mar. 5, 2025 (JP) 2025-034208

(51) Int. Cl. B25J 13/08; B25J 13/00

(52) U.S. Cl. CPC B25J 13/085; B25J 13/006

(57) ABSTRACT

A control system according to the present disclosure includes a gripping part configured to grip a gripping target object, a controller configured to control a movement of the gripping part, and a detection unit configured to detect a weight of the gripping target object gripped by the gripping part, in which the controller is configured to control, in a case where an instruction signal for instructing interruption of the control of the movement of the gripping part that grips the gripping target object in which a contained object is contained is received, the movement of the gripping part such that a posture of the gripping target object is a posture at a timing at which the weight of the gripping target object is heavier than a weight of the gripping target object at a timing at which the instruction signal is received.

### CROSS-REFERENCE TO RELATED APPLICATION

This application claims priority to Japanese Patent Application No. 2025-034208 filed on Mar. 5, 2025. The disclosure of the above-identified application, including the specification, drawings, and claims, is incorporated by reference herein in its entirety.

### BACKGROUND

### 1. Technical Field

The present disclosure relates to a control system.

### 2. Description of Related Art

In a control system that controls a movement of a gripping part that grips a container (gripping target object) in which contents such as a liquid are contained, the movement of the gripping part needs to be appropriately controlled such that the contents do not leak from the container.

As the related art, Japanese Patent No. 7255129 (JP 7255129 B) discloses a device including a gripping part that grips an object (gripping target object) containing a liquid or the like, and a controller that controls a movement of the gripping part.

### SUMMARY

In the related art, in a case where a part of the contents leaks from the gripping target object, an assumption is made that a control of stopping the movement of the gripping part that grips the gripping target object is performed. However, in a case where only a control of simply stopping the movement of the gripping part is performed, there is a possibility that the contents continue to leak from the gripping target object. That is, in the related art, there is a possibility that the operation of the gripping part that grips the gripping target object in which the contents are contained cannot be appropriately controlled.

The present disclosure has been made in view of the background, and an object thereof is to provide a control system capable of appropriately controlling an operation of a gripping part that grips a gripping target object in which contents are contained.

A control system according to the present disclosure includes
a gripping part configured to grip a gripping target object, and
a controller configured to control a movement of the gripping part.
   The control system further includes a detection unit configured to detect a weight of the gripping target object gripped by the gripping part.
   The controller is configured to control, when an instruction signal for instructing interruption of control of the movement of the gripping part that grips the gripping target object in which contents are contained is received, the movement of the gripping part such that a posture of the gripping target object is a posture at a timing at which the weight of the gripping target object is heavier than a weight of the gripping target object at a timing at which the instruction signal is received.
   In a case where a part of the contents such as a liquid leaks from the gripping target object, the control system brings the posture of the gripping target object closer to a posture before the part of the contents leaks. As a result, it is possible to suppress the contents from continuously leaking from the gripping target object, as compared to a case where a control of simply stopping the movement of the gripping part that grips the gripping target object is performed. That is, the control system can more appropriately control the operation of the gripping part that grips the gripping target object in which the contents are contained. The control system may be configured to control the movement of the gripping part by using a trained model constructed by machine learning.

According to the present disclosure, it is possible to provide a control system capable of more appropriately controlling an operation of a gripping part that grips a gripping target object in which contents are contained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing an example of an overall environment in which a control system according to Embodiment 1 is used;

FIG. 2 is an external perspective view showing an example of an external configuration of a robot;

FIG. 3 is a block diagram showing an example of a block configuration of the robot;

FIG. 4 is a block diagram showing an example of a block configuration of a remote terminal;

FIG. 5 is a flowchart showing a part of an operation of the control system according to Embodiment 1; and

FIG. 6 is a diagram for describing a part of the operation of the control system according to Embodiment 1.

### DETAILED DESCRIPTION OF EMBODIMENTS

Hereinafter, an embodiment will be described with reference to the drawings. Note that, since the drawings are drawn in a simplified manner, the technical scope of the embodiment should not be narrowly interpreted based on the description of the drawings. In addition, the same elements are designated by the same reference numerals and redundant description will not be repeated.

### Embodiment 1

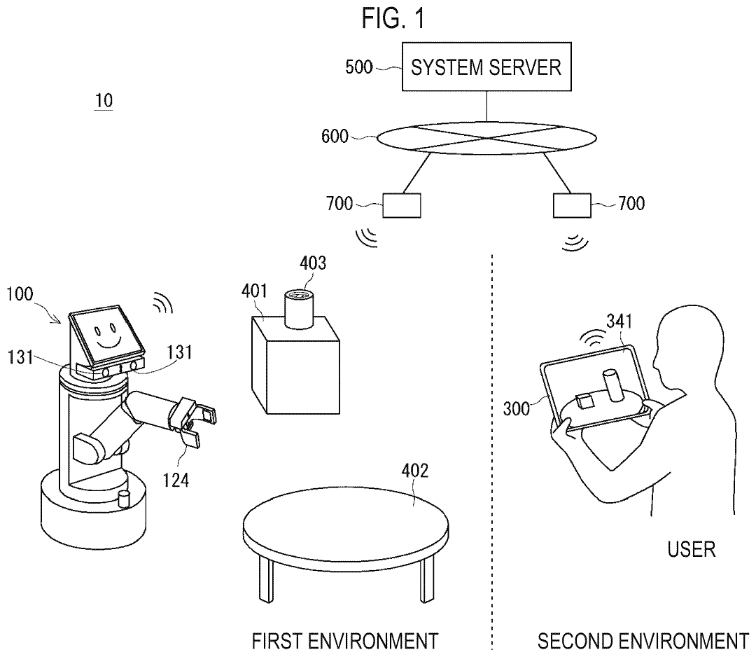

FIG. 1 is a conceptual diagram showing an example of an overall environment in which a control system 10 according to Embodiment 1 is used. A robot 100 that executes various operations in a first environment is remotely operated, via a system server 500 connected to the Internet 600, by operating a remote terminal 300 (operation terminal) by a user who is a remote operator in a second environment away from the first environment.

The robot 100 is connected to the Internet 600 via a wireless router 700 in the first environment. In addition, the remote terminal 300 is connected to the Internet 600 via the wireless router 700 in the second environment. The system server 500 is connected to the Internet 600. The robot 100 executes a gripping operation of a gripping target object (gripped object) by a hand (gripping part) 124, a transport operation of the gripping target object from a current location to a destination, and the like in response to the operation of the remote terminal 300 by the user.

In addition, in the present embodiment, the transport operation of the gripping target object from the current location to the destination includes an operation of transporting the gripping target object by traveling of the robot 100. In addition, the transport operation includes, for example, an operation of transporting the gripping target object gripped by the hand 124 by an arm operation without traveling the robot 100.

The robot 100 images the first environment in which the robot 100 is present by using a stereo camera 131 (imaging unit), and transmits the captured image to the remote terminal 300 via the Internet 600. In addition, the robot 100 recognizes a grippable object that can be gripped by the hand 124 based on the captured image. However, the robot 100 may recognize the grippable object based on operation information received from the remote terminal 300.

In the example of FIG. 1, a base 401, a table 402, and a container 403 are present in the first environment. The container 403 is placed on the base 401 and contains a contained object such as a liquid. In the present disclosure, the container 403 is recognized as the gripping target object by the robot 100.

The remote terminal 300 is, for example, a tablet terminal, and includes a display panel 341 in which a touch panel is disposed to be superimposed. The captured image received from the robot 100 is displayed on the display panel 341, and the user can indirectly visually recognize the first environment in which the robot 100 is present. In addition, the user can manually input handwritten information as the operation information, which is an image that simulates the operation content of the robot 100 with respect to the gripping target object, to the captured image displayed on the display panel 341. Alternatively, the user can input information on the operation content of the robot 100 as the operation information by pressing an operation button displayed on the display panel 341.

As a method of inputting the handwritten information, there is a method of touching a corresponding portion of the captured image on the touch panel disposed to be superimposed on the display panel 341 by using a finger, a touch pen, or the like of the user, but the present disclosure is not limited thereto. The image of the handwritten information may be an image consisting of only a figure such as a line, or may be an image consisting of a combination of a figure such as a line and a character. The handwritten information input by the user to the captured image is transmitted to the robot 100 via the Internet 600.

The remote terminal 300 is not limited to the tablet terminal, and the handwritten information input to the remote terminal 300 is not limited to a case where the handwritten information is input by touching the touch panel by using a finger, a touch pen, or the like of the user. For example, the remote terminal 300 is a virtual reality (VR) goggles. The handwritten information input to the remote terminal 300 may be input to the captured image displayed in the VR goggles by the user wearing the VR goggles operating a VR controller.

Alternatively, the remote terminal 300 may be a personal computer (PC) terminal. In this case, the user operates a mouse or a keyboard in accordance with a display content of a monitor, so that the operation information is input to the PC terminal that is the remote terminal 300.

The robot 100 estimates the gripping target object for which the gripping by the hand 124 is requested from the grippable object based on the grippable object recognized from the captured image and the operation information input by the user to the captured image. At the same time, the robot 100 estimates the operation content with respect to the gripping target object requested to the robot 100. The operation content with respect to the gripping target object requested to the robot 100 includes, for example, a method of performing the gripping operation of the gripping target object by the hand 124 and a method of performing the transport operation of the gripping target object from the current location to the destination.

### Example of External Configuration of Robot 100

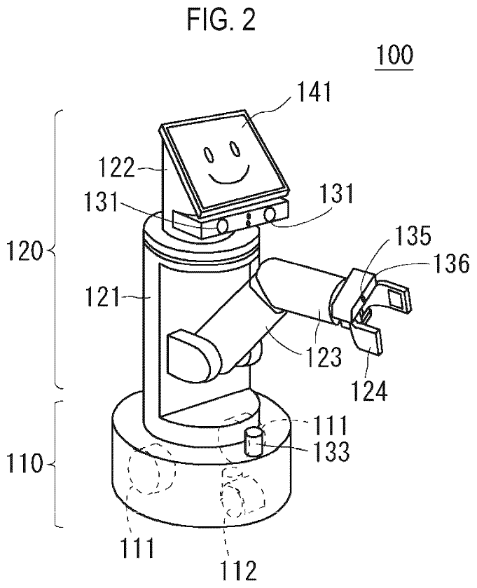

FIG. 2 is an external perspective view showing an example of an external configuration of the robot 100. The robot 100 is broadly configured by a carriage part 110 and a body part 120. The carriage part 110 includes two drive wheels 111 and one caster 112 that are in contact with a traveling surface below a housing having a cylindrical shape. The two drive wheels 111 are disposed such that rotation axes thereof match each other. Each of the drive wheels 111 is rotationally driven independently by a motor (not shown). The caster 112 is a driven wheel and follows the movement direction of the carriage part 110.

The carriage part 110 includes a laser scanner 133 at a peripheral edge portion of an upper surface. The laser scanner 133 scans a certain range in a horizontal plane for each step angle and outputs whether an obstacle is present in each direction. Further, in a case where the obstacle is present, the laser scanner 133 outputs a distance to the obstacle.

The body part 120 mainly includes a torso 121 mounted on the upper surface of the carriage part 110, a head 122 placed on the upper surface of the torso 121, an arm 123 supported on a side surface of the torso 121, and a hand 124 installed at a distal end part of the arm 123. The arm 123 and the hand 124 are driven via a motor (not shown), and the hand 124 grips the gripping target object. The torso 121 can rotate around a vertical axis with respect to the carriage part 110 by a driving force of a motor (not shown).

In addition, a hand camera 135 for recognizing a distance, a shape, a direction, and the like of the gripping target object gripped by the hand 124 is attached to the distal end part of the arm 123. Further, a weight detection unit (detection unit) 136 for detecting the weight of the gripping target object gripped by the hand 124 is attached to the distal end part of the arm 123. However, the weight detection unit 136 is not limited to the distal end part of the arm 123 as long as the weight of the gripping target object can be detected, and may be attached to, for example, the arm 123.

The head 122 mainly includes the stereo camera 131 and the display panel 141. The stereo camera 131 has a configuration in which two camera units having the same angle of view are disposed to be spaced apart from each other, and outputs a captured signal captured by each of the camera units.

The display panel 141 is, for example, a liquid crystal panel, and displays a face of a set character using an animation, or displays information on the robot 100 using text or an icon. In a case where the face of the character is displayed on the display panel 141, the display panel 141 can give an impression that the display panel 141 is a pseudo face part to the people around.

The head 122 can rotate around a vertical axis with respect to the torso 121 by a driving force of a motor (not shown). Therefore, the stereo camera 131 can image in any direction, and the display panel 141 can present the display content in any direction.

### Example of Block Configuration of Robot 100

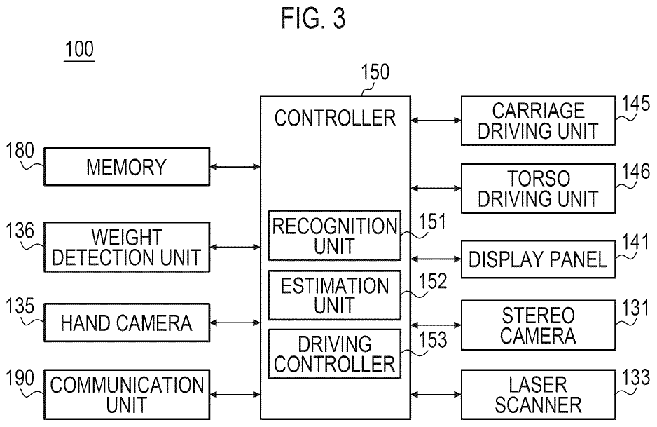

FIG. 3 is a block diagram showing an example of a block configuration of the robot 100. Here, main elements related to the estimation of the gripping target object and the estimation of the operation content of the robot 100 with respect to the gripping target object will be described, but the present disclosure is not limited thereto. For example, the robot 100 may also include other elements that contribute to each of the estimation of the gripping target object and the estimation of the operation content of the robot 100 with respect to the gripping target object, and other elements.

As shown in FIG. 3, the robot 100 includes a controller 150, a carriage driving unit 145, a torso driving unit 146, the display panel 141, the stereo camera 131, the laser scanner 133, the hand camera 135, the weight detection unit 136, a memory (storage unit) 180, and a communication unit 190.

The controller 150 is, for example, a central processing unit (CPU), and is stored in, for example, a control unit provided in the torso 121.

The carriage driving unit 145 includes the drive wheels 111 and a driving circuit or a motor for driving the drive wheels 111. The controller 150 executes the rotation control of the drive wheels by sending a driving signal to the carriage driving unit 145. In addition, the controller 150 receives a feedback signal such as an encoder from the carriage driving unit 145 to understand the movement direction and the movement speed of the carriage part 110.

The torso driving unit 146 includes the arm 123 and the hand 124, the torso 121 and the head 122, and a driving circuit or a motor for driving the arm 123 and the hand 124, the torso 121 and the head 122. The controller 150 realizes the gripping operation or the gesture by sending the driving signal to the torso driving unit 146. In addition, the controller 150 receives a feedback signal such as an encoder from the torso driving unit 146 to understand the position and the movement speed of the arm 123 and the hand 124, and the orientation and the rotation speed of the torso 121 and the head 122.

The display panel 141 receives and displays the image signal generated by the controller 150. In addition, as described above, the controller 150 generates the image signal of the character or the like and displays the image signal on the display panel 141.

The stereo camera 131 images the first environment in which the robot 100 is present in response to a request from the controller 150, and delivers the captured signal to the controller 150. The controller 150 executes image processing using the captured signal, or converts the captured signal into a captured image according to a predetermined format.

The laser scanner 133 detects whether an obstacle is present in the movement direction in response to a request from the controller 150, and delivers the detection signal, which is the detection result, to the controller 150.

The hand camera 135 is, for example, a distance image sensor, and is used to recognize the distance, the shape, the direction, the posture, and the like of the gripping target object. Here, the distance of the gripping target object is a distance from the hand 124 to the gripping target object. The direction of the gripping target object is a disposition direction of the gripping target object as viewed from the hand 124. The posture of the gripping target object is a tilt state of the gripping target object gripped by the hand 124.

The hand camera 135 includes an imaging element in which pixels that perform photoelectric conversion on an optical image incident from a target space are two-dimensionally arranged, and outputs the distance to the subject to the controller 150 for each pixel. Specifically, the hand camera 135 includes an irradiation unit that irradiates the target space with patterned light, and the imaging element that receives the reflected light outputs the distance to the subject captured by each pixel from the distortion or the size of the pattern in the image. As a result, the controller 150 understands the state of a wider peripheral environment by the stereo camera 131, and understands the state of the vicinity of the gripping target object by the hand camera 135.

The weight detection unit 136 is, for example, a load cell, and periodically detects the weight of the gripping target object and outputs the detection result to the controller 150.

The memory 180 is a non-volatile storage medium. The memory 180 is, for example, a solid state drive. The memory 180 stores various parameter values, functions, lookup tables, and the like used for the control or the calculation, in addition to the control program for controlling the robot 100. Further, the memory 180 stores a plurality of combinations of a weight Wt of the gripping target object detected by the weight detection unit 136 and a posture R of the gripping target object at a timing at which the weight Wt is detected. More preferably, the memory 180 stores a combination of a maximum value Wmax of the weight Wt of the gripping target object detected by the weight detection unit 136 and a posture Rmax of the gripping target object at a timing at which the weight Wt that reaches the maximum value Wmax is detected.

The communication unit 190 is, for example, a wireless LAN unit, and performs wireless communication with the wireless router 700. The communication unit 190 receives the operation information transmitted from the remote terminal 300 and delivers the operation information to the controller 150. In addition, the communication unit 190 transmits the captured image captured by the stereo camera 131 to the remote terminal 300 in response to the control of the controller 150.

The controller 150 executes the control of the entire robot 100 and various calculation processes by executing the control program read out from the memory 180. In addition, the controller 150 also plays a role as a function execution unit that executes various calculations or controls related to the control. As such a function execution unit, the controller 150 includes a recognition unit 151, an estimation unit 152, and a driving controller 153.

The recognition unit 151 mainly extracts a grippable region that can be gripped by the hand 124 and is shown in the captured image captured by the stereo camera 131, and recognizes the grippable region as the grippable object.

The estimation unit 152 estimates the gripping target object for which the gripping by the hand 124 is requested from the grippable object recognized by the recognition unit 151, and estimates the operation content with respect to the gripping target object requested to the robot 100.

Specifically, first, the estimation unit 152 estimates the gripping target object for which the gripping by the hand 124 is requested from the grippable object recognized by the recognition unit 151 based on the grippable object recognized from the captured image by the recognition unit 151 and the operation information with respect to the captured image. Thereafter, the estimation unit 152 estimates the distance, the direction, and the like of the gripping target object by analyzing the captured images of the stereo camera 131 or the hand camera 135. However, the estimation unit 152 may estimate the distance, the direction, and the like of the gripping target object by using a detection result of another sensor instead of analyzing the captured images of the stereo camera 131 or the hand camera 135. Thereafter, the estimation unit 152 estimates the operation content with respect to the gripping target object requested to the robot 100 from the operation information with respect to the captured image.

In addition, the estimation unit 152 can also detect whether an obstacle is present in the movement direction of the robot 100 by the detection signal from the laser scanner 133.

The driving controller 153 generates a path for moving the robot 100 to the vicinity of the gripping target object while avoiding the obstacle from the current position based on the distance, the direction, the presence or absence of the obstacle, and the like of the gripping target object. Then, the driving controller 153 transmits the driving signal corresponding to the generated path to the carriage driving unit 145. The carriage driving unit 145 moves the robot 100 to the vicinity of the gripping target object in response to the driving signal.

The driving controller 153 performs preparation for starting the operation with respect to the gripping target object requested to the robot 100 at a point in time when the robot 100 has moved to the vicinity of the gripping target object. Specifically, first, the driving controller 153 drives the arm 123 to a position where the hand camera 135 can observe the gripping target object. Thereafter, the driving controller 153 causes the hand camera 135 to image the gripping target object and recognizes the state of the gripping target object.

Then, the driving controller 153 determines details of the operation of each part of the robot 100 based on the state of the gripping target object and the operation content with respect to the gripping target object requested to the robot 100. The details of the operation of each part of the robot 100 are for realizing the operation content with respect to the gripping target object requested to the robot 100.

For example, the driving controller 153 generates a trajectory of the hand 124 for realizing the gripping operation of the gripping target object by the hand 124. In this case, the driving controller 153 generates the trajectory of the hand 124 such that a predetermined gripping condition is satisfied. The predetermined gripping condition includes a condition in a case where the hand 124 grips the gripping target object, a condition of a trajectory until the hand 124 grips the gripping target object, and the like. The condition in a case where the hand 124 grips the gripping target object is, for example, to prevent the arm 123 from being excessively extended in a case where the hand 124 grips the gripping target object. In addition, the condition of the trajectory until the hand 124 grips the gripping target object is, for example, in a case where the gripping target object is a drawer knob, the hand 124 takes a linear trajectory.

In a case where the driving controller 153 generates the trajectory of the hand 124, the driving controller 153 transmits the driving signal corresponding to the generated trajectory to the torso driving unit 146. The hand 124 performs the gripping operation on the gripping target object in response to the driving signal.

Alternatively, the driving controller 153 generates the trajectory of the hand 124 and the movement path of the robot 100 for realizing the transport operation of the gripping target object by the robot 100. In this case, the driving controller 153 transmits the driving signal corresponding to the generated trajectory of the hand 124 to the torso driving unit 146, and transmits the driving signal corresponding to the generated movement path of the robot 100 to the carriage driving unit 145. The hand 124 and the robot 100 perform the transport operation of the gripping target object in response to the driving signals thereof.

Further, the driving controller 153 controls the posture of the gripping target object based on a change in the weight of the gripping target object detected by the weight detection unit 136. For example, in a case where the gripping target object is a container that contains a contained object such as a liquid, it is considered that a part of the contained object unintentionally leaks from the gripping target object. In this case, in a case where only the movement of the hand 124 is simply stopped, the gripping target object remains tilted, and the contained object may continue to leak from the gripping target object. The contained object contained in the gripping target object is, for example, any of a liquid such as water or coffee, a powder such as sugar, or a plurality of solids such as a plurality of screws.

Therefore, in a case where an instruction signal STP for instructing interruption of the control of the movement of the hand 124 that grips the gripping target object in which the contained object is contained is received, the driving controller 153 controls the movement of the hand 124. Specifically, the driving controller 153 controls the movement of the hand 124 such that the posture of the gripping target object is a posture at a timing at which the weight of the gripping target object is heavier than a weight of the gripping target object at a timing at which the instruction signal STP is received. More preferably, in a case where the instruction signal STP is received, the driving controller 153 controls the movement of the hand 124 such that the posture of the gripping target object is a posture at a timing at which the weight of the gripping target object reaches a maximum value or a value close to the maximum value.

As described above, in a case where a part of the contained object such as a liquid leaks from the gripping target object, the control system 10 brings the posture of the gripping target object closer to a posture before the part of the contained object leaks. As a result, it is possible to bring the opening portion of the gripping target object closer to the vertical upward direction, as compared to a case where a control of simply stopping the movement of the hand 124 that grips the gripping target object is performed. Therefore, it is possible to suppress the contained object from continuously leaking from the gripping target object. That is, the control system 10 can more appropriately control the operation of the hand 124 that grips the gripping target object in which the contained object is contained.

The instruction signal generation unit that generates the instruction signal STP is provided in the remote terminal 300 or the robot 100. For example, the instruction signal STP is generated by the user who discovers that the contained object is leaking from the gripping target object operating the remote terminal 300, and is transmitted to the controller 150. Alternatively, the instruction signal STP is generated by the user operating an emergency stop button (not shown) attached to the robot 100, and is transmitted to the controller 150. Alternatively, the instruction signal STP is generated by detecting a decrease in the weight of the gripping target object by the weight detection unit 136, and is transmitted to the controller 150.

For example, a plurality of combinations of the detection value of the weight of the gripping target object in which the contained object is contained and the posture of the gripping target object at a timing at which the weight is detected may be stored in the memory 180. The information stored in the memory 180 is detected by the controller 150. In this case, the driving controller 153 extracts the posture at a timing at which the weight of the gripping target object is heavier than the weight of the gripping target object at a timing at which the instruction signal STP is received from the memory 180.

More preferably, the memory 180 further stores a combination of the maximum value Wmax of the weight Wt of the gripping target object detected by the weight detection unit 136 and the posture of the gripping target object at a timing at which the maximum value Wmax is detected. In this case, the driving controller 153 extracts the posture at a timing at which the weight of the gripping target object reaches the maximum value Wmax or a value close to the maximum value from the memory 180.

### Example of Block Configuration of Remote Terminal 300

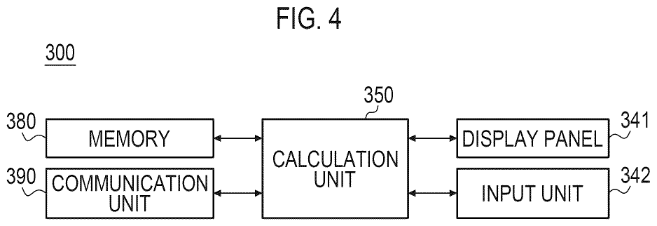

FIG. 4 is a block diagram showing an example of a block configuration of the remote terminal 300. Here, main elements related to a process of inputting the handwritten information to the captured image received from the robot 100 will be described, but the present disclosure is not limited thereto. For example, the remote terminal 300 may also include other elements that contribute to the process of inputting the handwritten information, and other elements.

As shown in FIG. 4, the remote terminal 300 includes a calculation unit 350, the display panel 341, an input unit 342, a memory (storage unit) 380, and a communication unit 390.

The calculation unit 350 is, for example, a CPU, and executes the control of the entire remote terminal 300 and various calculation processes by executing the control program read out from the memory 380.

The display panel 341 is, for example, a liquid crystal panel, and displays, for example, the captured image sent from the robot 100.

The input unit 342 includes a touch panel disposed to be superimposed on the display panel 341, a push button provided at a peripheral edge portion of the display panel 341, and the like. In addition, the input unit 342 delivers the handwritten information, which is an image that simulates the operation content of the robot 100 with respect to the gripping target object, input by the user by touching the touch panel with a finger or a touch pen, to the calculation unit 350.

The memory 380 is a non-volatile storage medium. The memory 380 is, for example, a solid state drive. The memory 380 stores various parameter values, functions, lookup tables, and the like used for the control or the calculation, in addition to the control program for controlling the remote terminal 300.

The communication unit 390 is, for example, a wireless LAN unit, and performs wireless communication with the wireless router 700. The communication unit 390 receives the captured image sent from the robot 100 and delivers the captured image to the calculation unit 350. In addition, the communication unit 390 transmits the handwritten information to the robot 100 in cooperation with the calculation unit 350.

In the present embodiment, a case where the handwritten information is input as the operation information to the remote terminal 300 has been described as an example, but the present disclosure is not limited thereto. For example, in a case where the remote terminal 300 is a PC terminal, the operation information by the keyboard or the mouse is input to the remote terminal 300 instead of the handwritten information. In this case, the remote terminal 300 includes a monitor instead of the display panel 341, and includes a keyboard, a mouse, or the like as the input unit 342 instead of the touch panel or the like.

### Flowchart

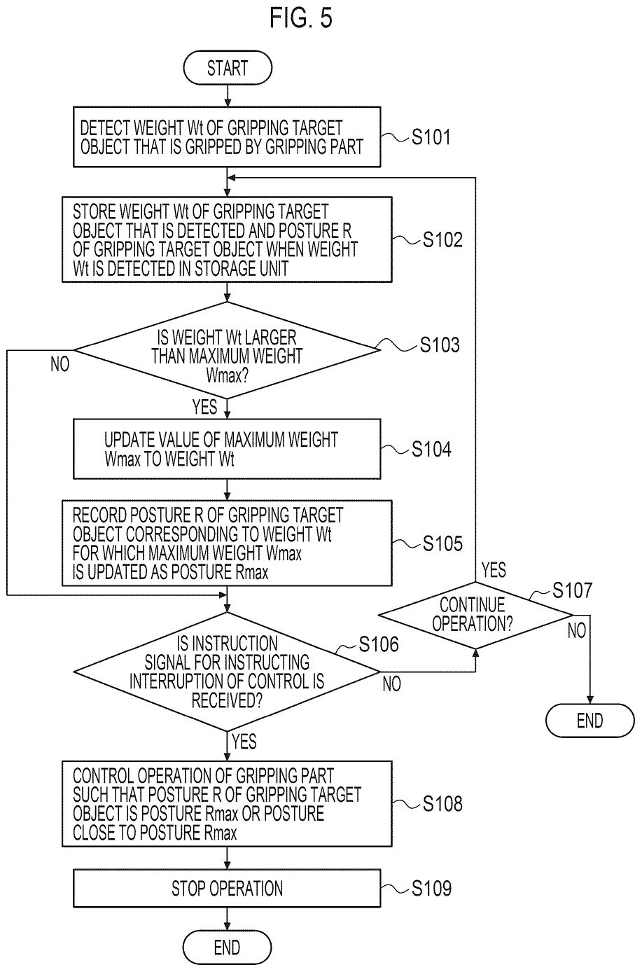

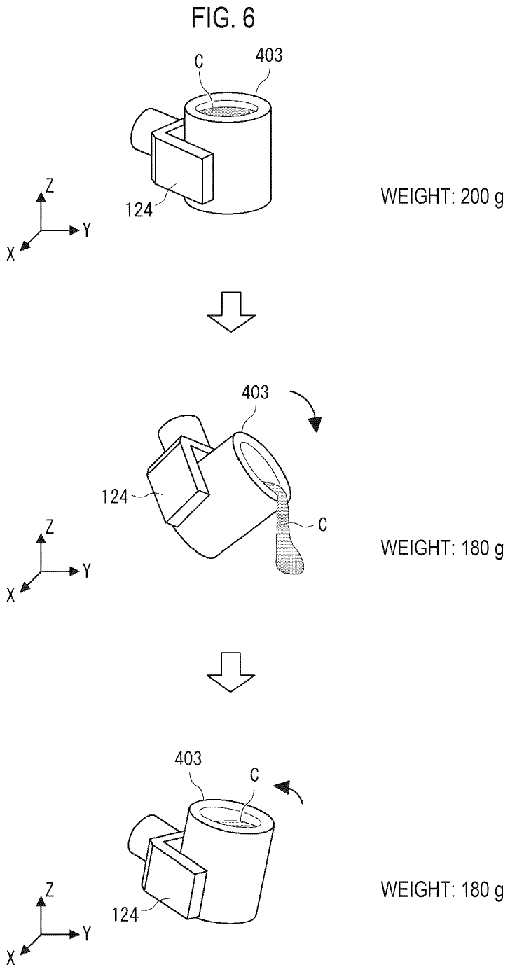

Subsequently, a part of an operation of the control system 10 will be described with reference to FIGS. 5 and 6. FIG. 5 is a flowchart showing a part of the operation of the control system 10. Hereinafter, a case where the robot 100 grips and lifts the container 403, which is the gripping target object placed on the base 401, by the hand 124, which is the gripping part, in the environment shown in FIG. 1 will be described as an example. Water C is contained in the container 403. Hereinafter, the container 403 in a state of containing the water C will be simply referred to as the container 403.

First, in the control system 10, the robot 100 detects the weight Wt of the container 403 that is gripped and lifted by the hand 124 (S101).

Thereafter, the robot 100 stores the weight Wt detected this time and the posture R of the container 403 at a timing at which the weight Wt is detected in the memory 180 (S102). As shown in an upper diagram of FIG. 6, here, information such as the weight Wt of 200 g and the axial direction of the container 403 having a cylindrical shape in the Z-axis direction (vertical direction) is stored in the memory 180.

Here, in a case where the weight Wt detected this time is larger than the maximum value Wmax of the weight Wt detected in the past (S103: YES), the robot 100 updates the maximum value Wmax to the weight Wt detected this time (S104). In addition, the robot 100 records the information on the posture R corresponding to the weight Wt for which the maximum value Wmax is updated as the posture Rmax (S105). On the other hand, in a case where the weight Wt detected this time is equal to or less than the maximum value Wmax of the weight Wt detected in the past (S103: NO), the robot 100 does not update the maximum value Wmax and the posture Rmax.

Thereafter, in a case where the instruction signal STP for instructing interruption of the control is not received (S106: NO), the robot 100 continues the periodic detection and recording of the weight Wt and the posture R and the update of the maximum value Wmax until the instructed operation is completed (S107: YES→S101 to S106: NO). Then, in a case where the instructed operation is completed, the robot 100 stops the operation (S107: NO).

Here, in a case where the instruction signal STP for instructing interruption of the control is received (S106: YES), the robot 100 controls the movement of the hand 124 such that the posture R of the container 403 is a posture at a timing at which the weight Wt of the container 403 reaches the maximum value Wmax or a value close to the maximum value (S108).

For example, as shown in a middle diagram of FIG. 6, the user who discovers that a part of the water C is leaking from the container 403 gripped by the hand 124 operates the remote terminal 300. In this case, an assumption is made that the instruction signal STP for instructing interruption of the control of the robot 100 is transmitted from the remote terminal 300 to the robot 100. In this case, in a case where only the movement of the hand 124 is simply stopped, the gripping target object remains tilted, and the water C may continue to leak from the container 403.

Therefore, for example, as shown in a lower diagram of FIG. 6, the robot 100 controls the movement of the hand 124 such that the posture of the container 403 is a posture at a timing at which the weight Wt of the container 403 reaches the maximum value Wmax of 200 g. Specifically, the robot 100 controls the movement of the hand 124 such that the axial direction of the container 403 having the cylindrical shape approaches the Z-axis direction. The robot 100 may control the movement of the hand 124 such that the axial direction of the container 403 having the cylindrical shape is the Z-axis direction, for example, as shown in the upper diagram of FIG. 6.

As a result, the robot 100 can bring the opening portion of the container 403 closer to the vertical upward direction, as compared to a case where a control of simply stopping the movement of the hand 124 that grips the container 403 is performed. Therefore, it is possible to prevent the water C from continuously leaking from the container 403.

Thereafter, the robot 100 stops the operation (S109).

As described above, in a case where a part of the contained object such as a liquid leaks from the gripping target object, the control system 10 according to the present disclosure brings the posture of the gripping target object closer to a posture before the part of the contained object leaks. As a result, it is possible to suppress the contained object from continuously leaking from the gripping target object, as compared to a case where a control of simply stopping the movement of the hand 124 that grips the gripping target object is performed. That is, the control system 10 according to the present disclosure can more appropriately control the operation of the hand 124 that grips the gripping target object in which the contained object is contained.

The present disclosure is not limited to the embodiment, and can be appropriately modified without departing from the spirit.

In the embodiment, the recognition unit 151 and the estimation unit 152 are provided in the robot 100, but the present disclosure is not limited thereto. All or a part of the recognition unit 151 and the estimation unit 152 may be provided in the remote terminal 300 or may be provided in the system server 500.

In addition, in the embodiment, the robot 100 and the remote terminal 300 exchange the captured image or the operation information via the Internet 600 and the system server 500, but the present disclosure is not limited thereto. The robot 100 and the remote terminal 300 may exchange the captured image or the operation information by direct communication.

In addition, in the embodiment, a case where the operation content of the robot 100 is controlled based on the operation information input to the remote terminal 300 has been described as an example, but the present disclosure is not limited thereto. For example, the operation terminal may be attached to the housing of the robot 100, and the operation content of the robot 100 may be controlled based on the operation information input to the operation terminal. In this case, the remote terminal 300 is not necessary. In addition, the robot 100 may not have a structure of moving as long as the robot 100 can grip and lift the gripping target object by the hand 124.

In addition, in the embodiment, the imaging unit (stereo camera 131) provided in the robot 100 is used, but the present disclosure is not limited thereto. The imaging unit may be any imaging unit provided at any location in the first environment in which the robot 100 is present. In addition, the imaging unit is not limited to the stereo camera, and may be a monocular camera or the like.

In addition, in the embodiment, the example has been described in which the operated target is the robot 100 including the hand 124 at the distal end of the arm 123 as the end effector, but the present disclosure is not limited thereto. The operated target may include an end effector and execute the gripping operation by using the end effector. In addition, the end effector may be a gripping part (for example, a suction part) other than the hand.

Further, the present disclosure can realize a part or all of the process of the control system 10 by causing the CPU to execute a computer program.

The program includes an instruction group (or software code) for causing a computer to execute one or more functions described in the embodiment in a case where the program is read into the computer. The program may be stored in a non-transitory computer-readable medium or a tangible storage medium. As an example, but not limited thereto, the computer-readable medium or the tangible storage medium includes a random-access memory (RAM), a read-only memory (ROM), a flash memory, a solid-state drive (SSD), or other memory technologies. In addition, the storage medium includes a CD-ROM, a digital versatile disc (DVD), a Blu-ray (registered trademark) disk, or other optical disk storage, a magnetic cassette, a magnetic tape, a magnetic disk storage, or other magnetic storage devices. The program may be transmitted on a transitory computer-readable medium or a communication medium. As an example, but not limited thereto, the transitory computer-readable medium or the communication medium includes electrical, optical, acoustic, or other forms of propagating signals.

What is claimed is:

1. A control system comprising:
a gripping part configured to grip a gripping target object; and
a controller configured to control a movement of the gripping part, wherein:
the control system further includes a detection unit configured to detect a weight of the gripping target object gripped by the gripping part; and
the controller is configured to control, when an instruction signal for instructing interruption of control of the movement of the gripping part that grips the gripping target object in which contents are contained is received, the movement of the gripping part such that a posture of the gripping target object is a posture at a timing at which the weight of the gripping target object is heavier than a weight of the gripping target object at a timing at which the instruction signal is received.

2. The control system according to claim 1, wherein the controller is configured to control, when the instruction signal for instructing the interruption of the control of the movement of the gripping part that grips the gripping target object in which the contents are contained is received, the movement of the gripping part such that the posture of the gripping target object is a posture at a timing at which the weight of the gripping target object is at a maximum value.

3. The control system according to claim 1, further comprising a storage unit configured to store a plurality of combinations of a detection value of a weight of the gripping target object in which the contents are contained and a posture of the gripping target object at a timing at which the weight of the gripping target object is detected, wherein the controller is configured to extract, when the instruction signal for instructing the interruption of the control of the movement of the gripping part that grips the gripping target object in which the contents are contained is received, from the storage unit, the posture at the timing at which the weight of the gripping target object is heavier than the weight of the gripping target object at the timing at which the instruction signal is received.

4. The control system according to claim 1, further comprising an instruction signal generation unit configured to generate the instruction signal, wherein the instruction signal generation unit is configured to generate the instruction signal at at least any one of a timing at which a decrease in the weight of the gripping target object is detected by the detection unit or a timing at which a stop button is operated.

5. The control system according to claim 1, wherein the contents are any of a liquid, a powder, and a plurality of solids.
